(19) United States
(12) Patent Application Publication
(10) Pub. No.: US 2009/0310991 A1
(43) Pub. Date: Dec. 17, 2009

(54) IMAGE FORMING APPARATUS, IMAGE FORMING SYSTEM, COMPUTER READABLE MEDIUM STORING PROGRAM AND IMAGE FORMING METHOD

(75) Inventor: Masayuki ISOGAI, Ebina-shi (JP)

Correspondence Address: SUGHRUE MION, PLLC, 2100 PENNSYLVANIA AVENUE, N.W., SUITE 800, WASHINGTON, DC, 20037, US

(73) Assignee: FUJI XEROX CO., LTD., Tokyo (JP)

(21) Appl. No.: 12/323,797

(22) Filed: Nov. 26, 2008

(30) Foreign Application Priority Data
Jun. 17, 2008 (JP) 2008-157695

(51) Int. Cl. G03G 15/00

(52) U.S. Cl. 399/45

(57) ABSTRACT

An image forming apparatus includes a detecting unit that detects a size of a document,
a scanning unit that scans a document image on the basis of the document size detected by the detecting unit, a storage unit that stores a plurality of image data pieces regarding the document image scanned by the scanning unit, an adding unit that adds, to the image data stored in the storage unit, data to convert an area corresponding to a difference between a size of a printing sheet and the size of the document, into predetermined image, and an image output unit that outputs image data to which data to convert an area corresponding to the difference between the printing sheet size and the document size into predetermined image, has been added by the adding unit onto a printing sheet of a designated size.

### CROSS-REFERENCE TO RELATED APPLICATIONS

This application is based on and claims priority under 35 USC 119 from Japanese Patent Application No. 2008-157695 filed Jun. 17, 2008.

### BACKGROUND

### Technical Field

The present invention relates to an image forming apparatus, an image forming system, a computer readable medium storing a program and an image forming method.

### SUMMARY

According to an aspect of the present invention, there is provided an image forming apparatus including: a detecting unit that detects a size of a document, a scanning unit that scans a document image on the basis of the document size detected by the detecting unit,

a storage unit that stores a plurality of image data pieces regarding the document image scanned by the scanning unit, an adding unit that adds, to the image data stored in the storage unit, data to convert an area corresponding to a difference between a size of a printing sheet and the size of the document, into predetermined image, and an image output unit that outputs image data to which data to convert an area corresponding to the difference between the printing sheet size and the document size into predetermined image, has been added by the adding unit onto a printing sheet of a designated size.

### BRIEF DESCRIPTION OF THE DRAWINGS

An exemplary embodiment of the present invention will be described in detail based on the following figures, wherein:

FIG. 1 shows the system configuration of an image forming apparatus which is an exemplary embodiment of the present invention;

FIG. 2 is a block diagram showing the hardware configuration of an image forming apparatus 10 of the exemplary embodiment of the invention;

FIG. 3 is a block diagram showing the functional configuration of the image forming apparatus 10 of the exemplary embodiment of the invention;

FIG. 4 shows six sensors SNS1 through SNS6 provided in an auto document feeder 40;

FIG. 5 shows a section of the auto document feeder 40 in a side view;

FIG. 6 is a flowchart showing the actions of the image forming apparatus 10 of the exemplary embodiment of the invention in the processing of copying;

FIG. 7 illustrates outputting of an A4 size document onto an A3 size printing sheet;

FIGS. 8A and 8B illustrate the copying operation in the image forming apparatus 10 of the exemplary embodiment of the invention when an A4 size document is to be outputted to an A3 size printing sheet;

FIG. 9 illustrates the time difference taken to complete printing between scanning based on the printing sheet size and scanning based on the document size;

FIGS. 10A and 10B illustrate a case in which two documents smaller than the A4 size are outputted to an A3 size printing sheet;

FIG. 11 is a flowchart showing the actions of the image forming apparatus 10 of the exemplary embodiment of the invention in the processing to shift the document scanning area;

FIGS. 12A and 12B illustrate cases in which an A4 size document is shifted to a certain extent and outputted to an A3 size printing sheet;

FIG. 13 illustrates a function to delete the part of an image contained in a frame area inward from the outer circumference of a document to an extent prescribed by the user (frame removal);

FIG. 14 is a flowchart showing the actions of the image forming apparatus 10 of the exemplary embodiment of the invention to process frame removal;

FIGS. 15A and 15B illustrate cases in which a non-standard size document slightly smaller than A4 is outputted with frame removed to an A4 size printing sheet;

FIGS. 16A and 16B illustrate a function to extract or delete a specific area of a document;

FIG. 17 is a flowchart showing the actions of the image forming apparatus 10 of the exemplary embodiment of the invention in the operation to process extraction or deletion of a specific area; and

FIGS. 18A and 18B illustrate cases in which a non-standard size document slightly smaller than A4 is outputted with a specific area deleted to an A4 size printing sheet.

### DETAILED DESCRIPTION

Next, an exemplary embodiment of the present invention will be described in detail below with reference to accompanying drawings.

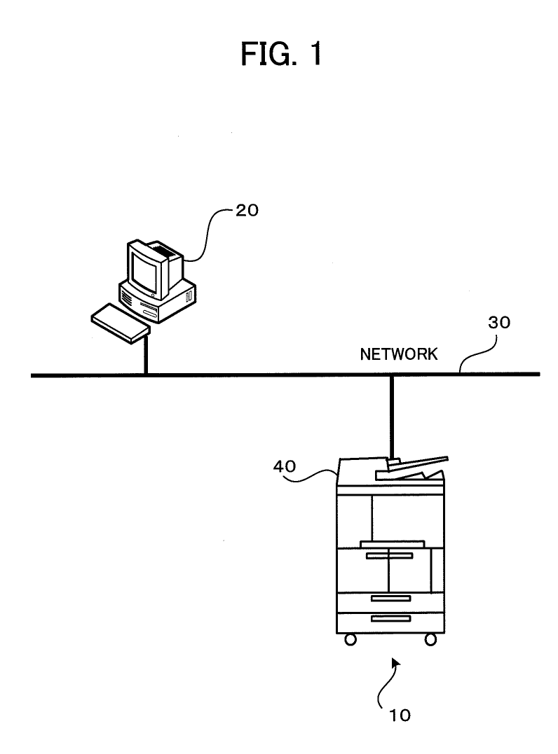

FIG. 1 shows the system configuration of an image forming system including an image forming apparatus which is an exemplary embodiment of the present invention. The image forming system in the exemplary embodiment of the invention includes an image forming apparatus 10 and a terminal device 20 connected to each other by a communication path such as a network 30 as shown in FIG. 1.

The terminal device 20 generates print data and transmits the generated print data to the image forming apparatus 10 via the network 30. The image forming apparatus 10 receives the print data transmitted from the terminal device 20, and outputs, onto a printing sheet, an image corresponding to the print data. One example of the image forming apparatus 10 is a device commonly known as a multifunction printer having plural functions including printing, scanning, copying and facsimile. A version of the image forming apparatus 10 incorporates an auto document feeder 40. This auto document feeder 40 has a function to successively feed each of stacked documents set on a document tray to a scanner.

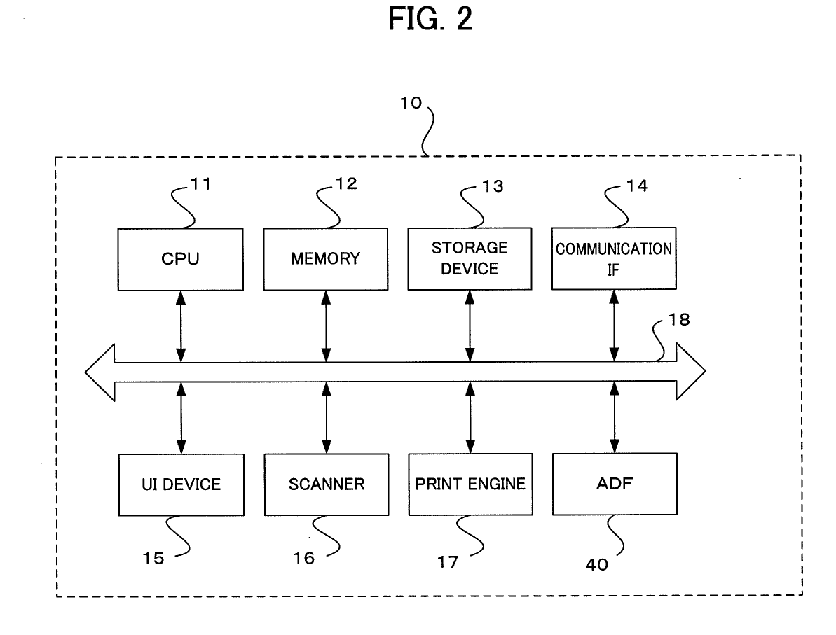

Next, the hardware configuration of the image forming apparatus 10 in the image forming system in this exemplary embodiment is shown in FIG. 2.

The image forming apparatus 10, as shown in FIG. 2, has a CPU 11, a memory 12, a storage device 13 such as a hard disk drive (HDD), a communication interface (IF) 14 which transmits and receives data to and from an external device or the like via the network 30, a user interface (UI) device 15 including a touch panel or a liquid crystal display and a keyboard, a scanner 16, a print engine 17 and an auto document feeder (ADF) 40. These constituent elements are connected to one another via a control bus 18.

The CPU 11 controls the operation of the image forming apparatus 10 by executing prescribed processing in accordance with a control program stored in the memory 12 or the storage device 13.

Although the CPU 11 in this exemplary embodiment is supposed to read out a control program stored in the memory 12 or the storage device 13 and execute it, it is also possible to store the program in a storage medium such as a CD-ROM and provide the same to the CPU 11.

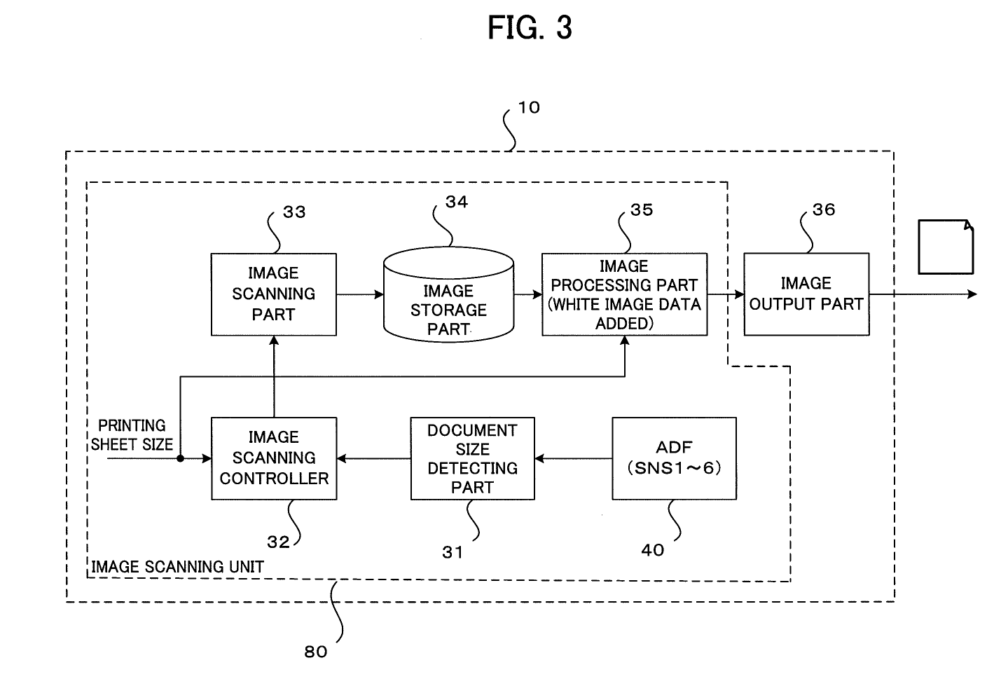

FIG. 3 is a block diagram showing the functional configuration of the image forming apparatus 10 in the exemplary embodiment of the invention realized by the execution of the control program.

The image forming apparatus 10 of this exemplary embodiment is provided with an image scanning unit 80 and an image output part 36 as shown in FIG. 3. The image scanning unit 80 has at least an auto document feeder (ADF) 40, a document size detecting part 31, an image scanning controller 32, an image scanning part 33, an image storage part 34 and an image processing part 35.

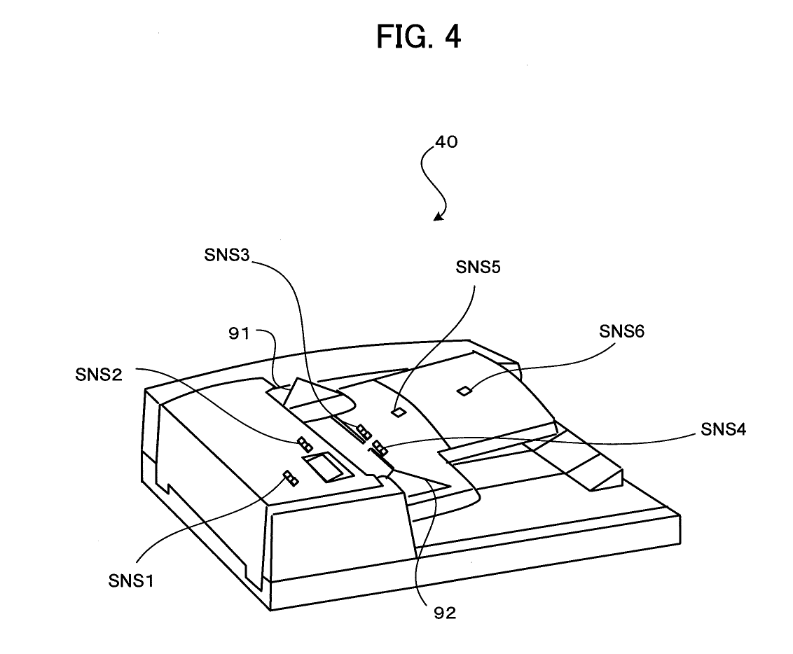

The auto document feeder 40 functions as a document carrying unit that successively carries each of documents placed on a document tray to a prescribed document scanning position. This auto document feeder 40 is provided with six sensors SNS1 through SNS6 as shown in FIG. 4. The SNS2 through SNS6 are plural sensors disposed on the document tray provided to detect a size candidate for the documents placed on the document tray of the auto document feeder 40. The SNS1 is provided to detect the actual size of the document carried by the auto document feeder 40.

The sensor SNS2 is provided to detect the presence or absence of a document, namely whether or not a document is placed on the document tray, and has no part in actual determination of the document size. The sensors SNS3 and SNS4 are intended for detecting the width of the document in the main-scanning direction. The SNS3 is provided to detect any shift of a guide 92, and the output logic varies according to the position of the guide 92. The SNS4 is provided to detect any shift of a guide 91, and the output logic varies according to the position of the guide 91. The sensors SNS5 and SNS6 are intended to detect whether or not a document is mounted above. If a document 60 is placed on the document tray, a width corresponding to its size over the sensors SNS5 and SNS6 is blocked to enable SNS5 and SNS6 to detect the presence of the document over them.

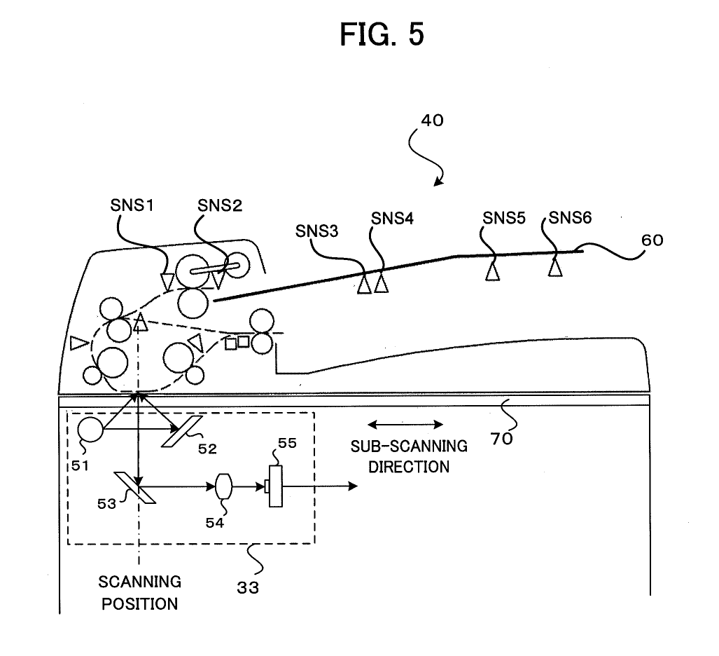

A section of this auto document feeder 40 in a side view is shown in FIG. 5. As shown in FIG. 5, the output logics of the sensor SNS2 through SNS6 vary when a document 60 is placed on the document tray in the auto document feeder 40. Therefore, the size of the document 60 placed on the document tray can be estimated by the sensors SNS2 through SNS6. Mere placement of a document on the document tray is not enough to enable the sensor SNS1 to measure the document size, but the SNS1 can measure the document size only when the carriage of the document starts. More specifically, the sensor SNS1 can accurately measure the document size in the sub-scanning direction of the document from the point of time when the SNS1 detects the passage of the document and its carriage speed.

Since mere placement of a document on the document tray thus is not enough to enable the sensor SNS1 to accurately measure the document size, it is assumed that the document is standard-sized and the actual document size is estimated on the basis of the result of detection of the presence or absence of a document over the sensors SNS2 through SNS6. Then, the first document is carried by the auto document feeder 40, and its passage of the sensor SNS1 enables the document size to be accurately measured.

As shown in FIG. 5, the image scanning part 33 shown in FIG. 3 is disposed in the scanning position to which the document is carried by the auto document feeder 40.

The image scanning part 33, including a xenon lamp 51 for irradiating the document, reflective mirrors 52 and 53, an image forming lens 54 and a photoelectric converter element 55 such as a charge coupled device (CCD) scans the image of a document carried by the auto document feeder 40 or that of a document placed on a platen glass 70.

The image scanning part 33, disposed on a carriage (not shown), is movable in the sub-scanning direction. For this reason, when the image of a document placed on the platen glass 70 is to be scanned, the image scanning part 33 can scan the document while moving in the sub-scanning direction. Or when the image of a document placed on the document tray is to be scanned, the image scanning part 33 can successively scan the images of documents fed from the document tray by moving to the document scanning position to which the documents are carried. The sub-scanning direction in this context is the same as the direction in which printing sheets are carried and perpendicular to the main-scanning direction. The main-scanning direction is the direction in which a deflected laser beam scans the document when an image is to be formed on a printing sheet.

The document size detecting part 31 detects the size of the document placed on the document tray of the auto document feeder 40 on the basis of output signals from the sensors SNS1 through SNS6 disposed on the auto document feeder 40. The document size in this context is determined by the dimensions in the longitudinal and lateral dimensions of the document scanned by the image scanning part 33.

The document scanning controller 32 controls the image scanning part 33 so as to cause a document image equivalent to the size of the document detected by the document size detecting part 31 to be scanned.

The image scanning part 33 scans only as much of the document carried to the document scanning position under the control of the image scanning controller 32 or the image of the document placed on the platen glass 70 as the size of the document. The image storage part 34 stores image data equivalent to the size of the document scanned by the image scanning part 33.

The image processing part 35 is intended for subjecting image data stored in the image storage part 34 to various modes of image processing such as color conversion. The image processing part 35 performs, as a mode of such image processing, processing to add, to image data stored in the image storage part 34, data to convert an area corresponding to a difference between the printing sheet size and the document size, into predetermined image. The processing to add data to obtain a predetermined image in this context means processing to add predetermined data by the user, for instance processing to add white image data. Where the color of the printing sheet is not white, it may be processing to add image data of the same color as the color of the printing sheet. The processing to data to obtain a predetermined image is not limited to adding data of a specific color.

The image output part 36 outputs, to a printing sheet of a designated size, the image data having undergone various modes of image processing by the image processing part 35 including the addition of white image data. The printing sheet size in this context is a size specified by the dimensions in the longitudinal and lateral dimensions of the printing sheet, such as the A4 size or the B5 size.

Next, the operation of the image forming apparatus 10 of the exemplary embodiment of the invention will be described in detail with reference to the accompanying drawings.

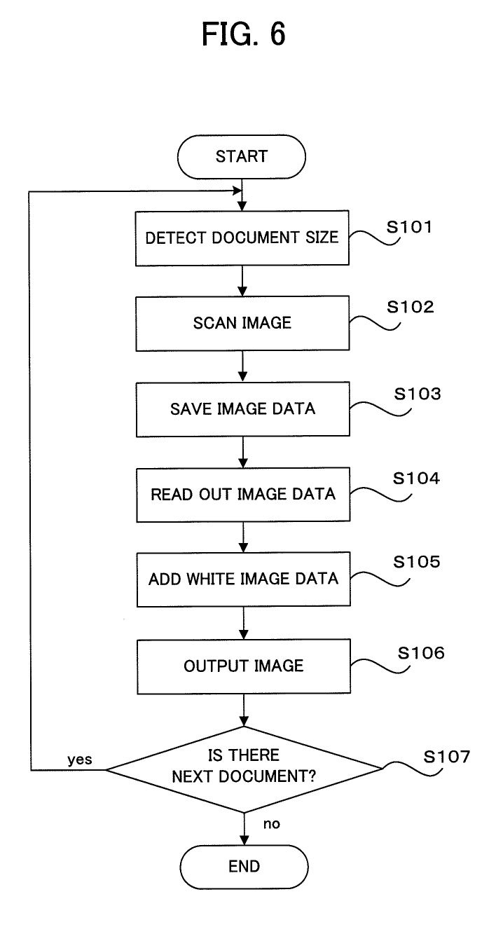

FIG. 6 is a flowchart showing the actions of the image forming apparatus 10 of the exemplary embodiment of the invention in the processing of copying.

First, when a document which is to be duplicated (copied) is set on the document tray of the auto document feeder 40, the document size detecting part 31 detects a document size candidate on the basis of the logics of output signals from the SNS2 through SNS6. When the document is carried to the auto document feeder 40, the document size detecting part 31 detects the accurate size of the document in the sub-scanning direction according to an output signal from the SNS1 (step S101).

Next, the image scanning controller 32 controls the document scanning part 33 so as to scan a document equivalent in size to the detected document size on the basis of the document size detected by the document size detecting part 31 (step S102). Then, the document image data scanned by the image scanning part 33 is saved in the image storage part 34 (step S103).

Next, the image data saved in the image storage part 34 is read out (step S104), and the image processing part 35 subjects the image data read out of the image storage part 34 to various modes of image processing. As one of these modes of image processing, if the designated printing sheet size is greater in size than the scanned document image, the image processing part 35 performs processing to add, to image data stored in the image storage part 34, an image of which an area representing the difference between the printing sheet size and the document size is predetermined by the user (step S105). In this exemplary embodiment, processing to add white image data is supposed to be performed (step S105).

Then, the image output part 36 forms an image on the basis of the image data having gone through image processing, such as the addition of white image data, by the image processing part 35 and outputs it (step S106) This processing from the steps S101 through S106 is repeated until there is no longer a document (step S107).

In the image forming apparatus 10 of this exemplary embodiment, similar processing may be performed not only in outputting image data scanned by the image scanning part 33 onto printing sheets in the image output part 36 but also in storing image data scanned by the image scanning part 33 into a specific storage area (e.g. a storage area set as a “Confidential” box) in the image forming apparatus 10 or in outputting the same via a communication path such as the network 30 to a specific storage area in the terminal device 20 or the like. In such a case, image data to which white image data has been added into an area corresponding to the difference between the printing sheet size and the document size is stored into or outputted to the specific storage area by the image processing part 35.

### SPECIFIC EXAMPLE 1

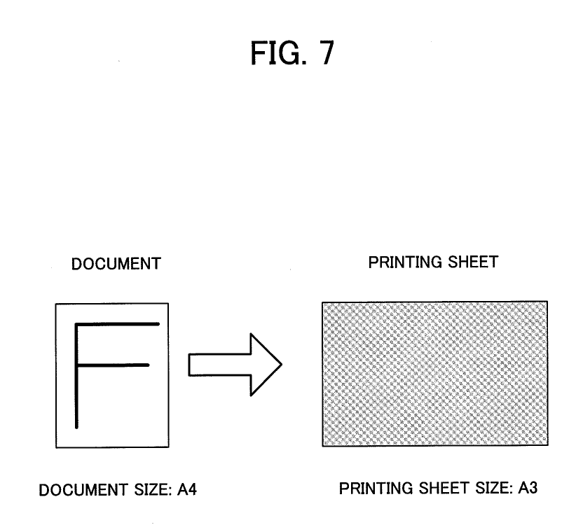

Next, the actions of the image forming apparatus 10 of this exemplary embodiment in the copying processing will be described with reference to a specific example, in which an A4 size document is to be outputted to an A3 size printing sheet as shown in FIG. 7.

In the image forming apparatus 10 of this exemplary embodiment, the image scanning controller 32 controls the image scanning part 33 so as to cause a document image equivalent to the detected document size to be scanned when the designated printing sheet size is greater than the detected document size. Thus, the image scanning controller 32 controls the image scanning part 33 so as to cause the document image to be scanned with reference to the document size.

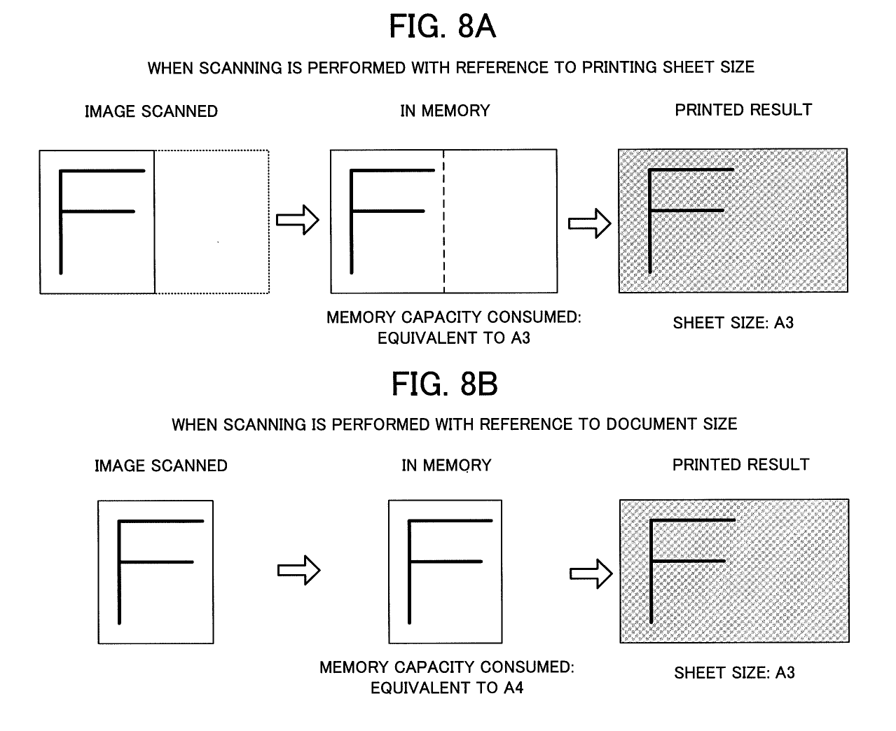

FIG. 8A shows a case in which scanning is performed with reference to the printing sheet size and FIG. 8B shows a case in which scanning is performed with reference to the document size.

When scanning is performed with reference to the printing sheet size where the document size is A4 and the designated printing sheet size is A3, an image equivalent to A3 including an A4 document image is scanned as shown in FIG. 8A. As a result, A3 size image data are obtained. For this reason, the image storage part 34 for storing image data requires a memory capacity for the A3 size. Finally, the image is outputted to an A3 size printing sheet on the basis of this A3 size image data.

When scanning is performed with reference to the document size as in the image forming apparatus 10 of this exemplary embodiment where the document size is A4 and the designated printing sheet size is A3, an image equivalent to only A4 is scanned as shown in FIG. 8B irrespective of the printing sheet size. As a result, A4 size image data are obtained. For this reason, the image storage part 34 for storing image data requires a memory capacity only for an equivalent of the A4 size. In order to output the A4 size image data read out of the image storage part 34 to the A3 size printing sheet, white image data is added to an area representing the difference between the A3 size and the A4 size to obtain A3 size image data. Finally, the image is outputted to an A3 size printing sheet on the basis of this A3 size image data.

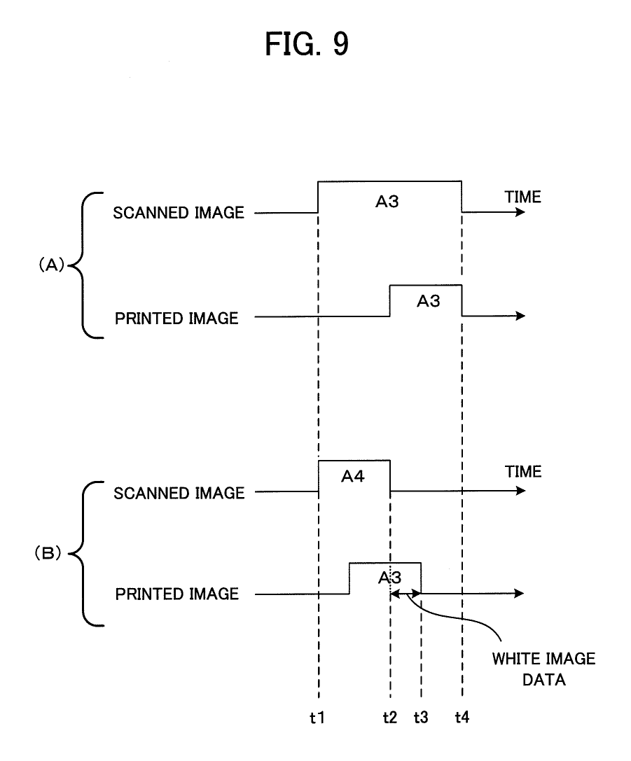

Next, the difference in the length of time taken to complete printing between a case in which scanning is performed with reference to the printing sheet size and a case in which scanning is performed with reference to the document size will be described with reference to FIGS. 9A and 9B.

The description here will refer to a case in which the document size is A4 and the designated printing sheet size is A3 as shown in FIG. 7 to FIG. 8B. It is supposed in the described case that the printing speed in the image output part 36 is twice as fast as the scanning speed in the image scanning part 33.

When scanning is performed with reference to the printing sheet size, the image scanning part 33 has to scan image data equivalent to the A3 size. For this reason, even if scanning is started at a point of time t1, printing will not be completed until a point of time t4 as shown in FIG. 9(A). On the other hand, when scanning is performed with reference to the document size, the image scanning part 33 needs to scan image data equivalent to only the A4 size. For this reason, as shown in FIG. 9(B), if scanning is started at the point of time t1, printing of image data equivalent to the A4 size will be completed by a point of time t2, and the whole printing will be finished by a point of time t3 when the printing of the remaining area equivalent to A4 where the remaining white image data is added is completed.

### SPECIFIC EXAMPLE 2

Next, the actions of the image forming apparatus 10 of this exemplary embodiment when it executes a function to collectively output plural images put together into a single image (collective printing function) will be described.

When such a function to collectively output plural images put together into a single image is selected, the image processing part 35 in this exemplary embodiment adds white image data to the area of the difference between the area in which the image data of plural images stored in the image storage part 34 is put together and the area of the printing sheet size.

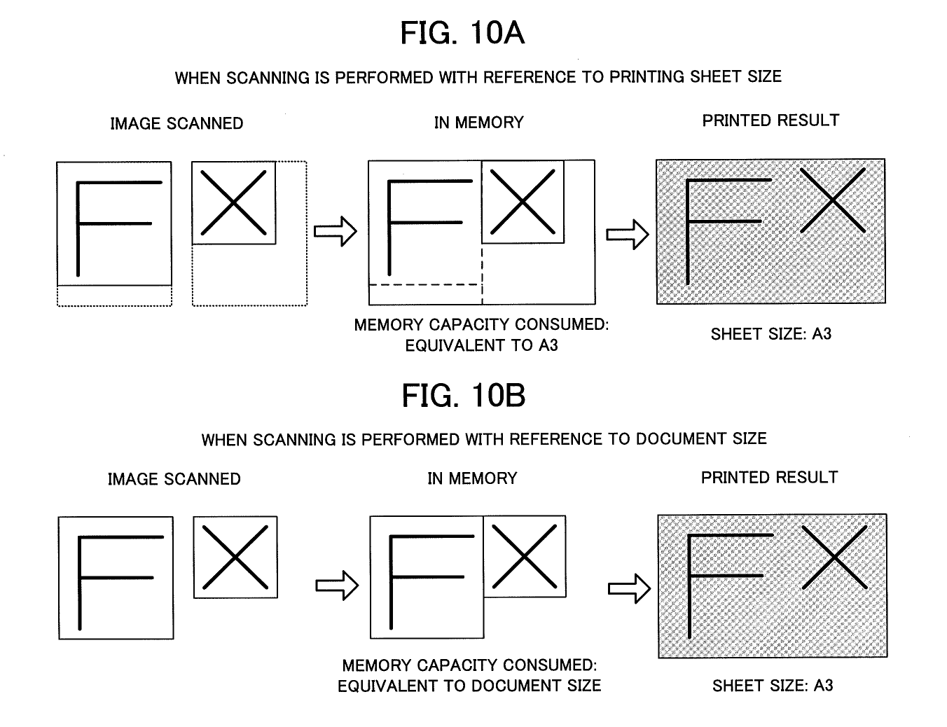

The description here will refer to a case in which two documents smaller than A4 in size are to be outputted to an A3 size printing sheet as shown in FIGS. 10A and 10. FIG. 10A shows a case in which scanning is performed with reference to the printing sheet size and FIG. 10B shows a case in which scanning is performed with reference to the document size.

When scanning is performed with reference to the printing sheet size where an image equivalent to the A4 size is scanned for each of the two documents as shown in FIG. 10A, two sets of A4 size image data are obtained. As a result, image data of the A3 size is obtained. For this reason, in order to store the image data, the image storage part 34 requires a memory capacity for the A3 size. Finally, the two sets of A4 size image data are synthesized into one set of A3 size image data, and the image is outputted to an A3 size printing sheet on the basis of this A3 size image data.

When scanning is performed with reference to the document size as in this image forming apparatus 10 of this exemplary embodiment, an image equivalent to only the document size is scanned for the two documents as shown in FIG. 10B. As a result, image data of the document size is obtained. For this reason, the image storage part 34 for storing image data requires a memory capacity only for an equivalent of the document size. In order to output the two sets of image data read out of the image storage part 34 to a single A3 size printing sheet, white image data is added to an area representing the difference between the area in which the two sets of image data are put together and the A3 size to obtain A3 size image data. Finally, the image is outputted to an A3 size printing sheet on the basis of this A3 size image data.

### SPECIFIC EXAMPLE 3

Next, the actions of the image forming apparatus 10 of this exemplary embodiment when it executes a function to shift the document scanning area to a certain extent will be described.

When a designation to shift the document scanning area to a certain extent is given, the image scanning part 33 in this exemplary embodiment scans the document image contained in the document scanning area shifted to that extent, and the image storage part 34 stores image data of part of the document scanned by the image scanning part 33.

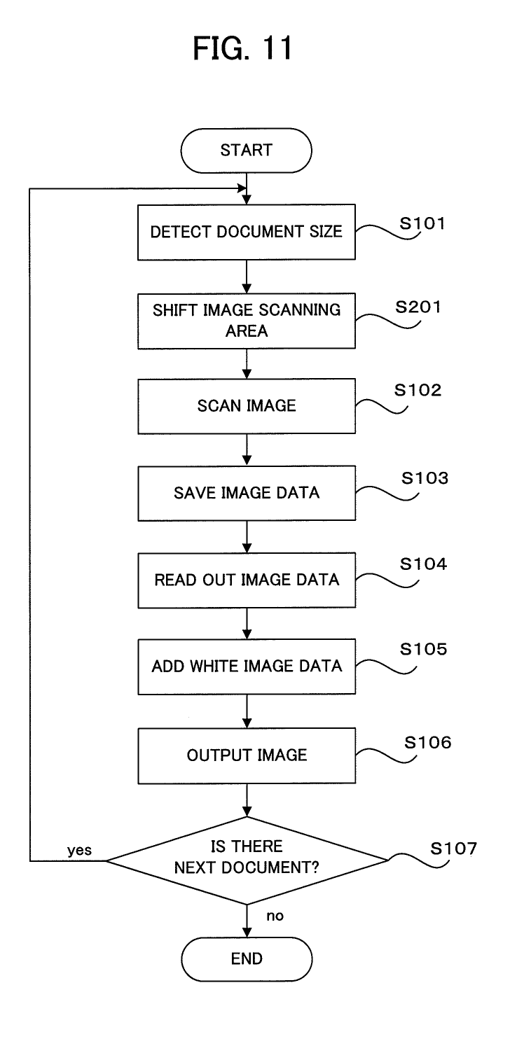

A flowchart showing the actions of the image forming apparatus 10 of this exemplary embodiment in shifting the document scanning area is given as FIG. 11. This flowchart of FIG. 11 represents the addition, to the flowchart of FIG. 6, of step S201 at which the image scanning area is shifted. Thus in the image forming apparatus 10 of this exemplary embodiment, the image scanning area is shifted after step S101 at which the document size is detected (step S201), and image scanning at step S102 is accomplished following it.

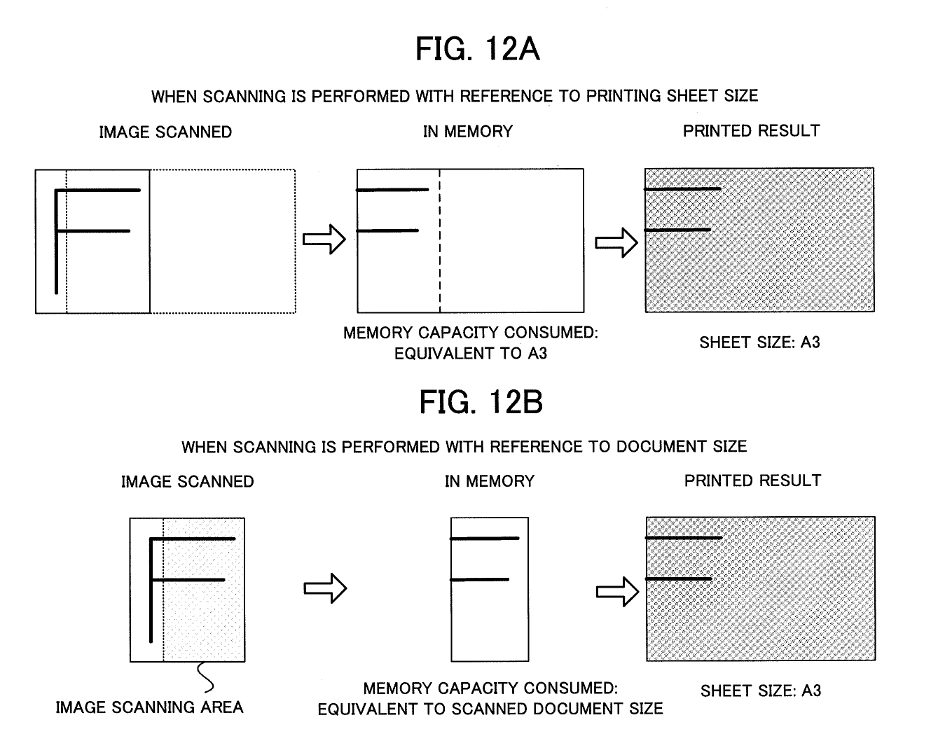

A specific example of this operation to shift the image scanning area will be described with reference to FIGS. 12A and 12B. FIGS. 12A and 12B illustrate cases in which an A4 size document is shifted to a certain extent and outputted to an A3 size printing sheet. Further, FIG. 12A shows a case in which scanning is performed with reference to the printing sheet size and FIG. 12B shows a case in which scanning is performed with reference to the document size.

When scanning is performed with reference to the printing sheet size, an image equivalent to the A3 size including the A4 size document image shifted to a certain extent is scanned as shown in FIG. 12A. As a result, A3 size image data is obtained. For this reason, in order to store the image data, the image storage part 34 requires a memory capacity for the A3 size. Finally, the image is outputted to an A3 size printing sheet on the basis of this A3 size image data.

When scanning is performed with reference to the document size as in this image forming apparatus 10 of this exemplary embodiment, only the document image contained in the image scanning area resulting from the shifting of the document to a certain extent is scanned irrespective of the printing sheet size as shown in FIG. 12B, an image regarding a part of the A4 document size being scanned. As a result, an image smaller than the A4 size is obtained. For this reason, the image storage part 34 for storing image data requires only a smaller memory capacity than that for the A4 size. To output, to an A3 size printing sheet, the image data of only a part of the document image read out of the image storage part 34, white image data is added to an area representing the difference between the A3 size and the part of the document image to obtain A3 size image data. Finally, the image is outputted to an A3 size printing sheet on the basis of this A3 size image data.

### SPECIFIC EXAMPLE 4

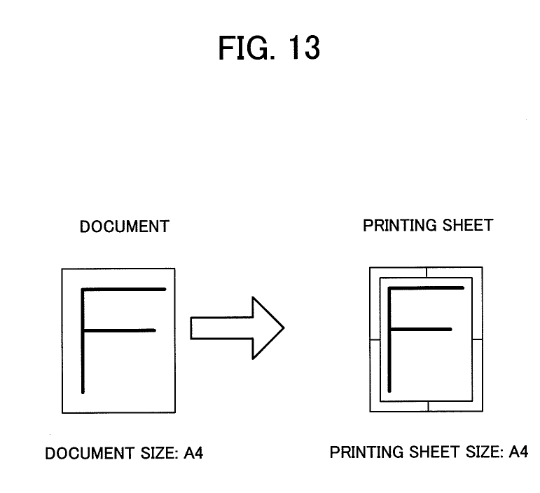

Next, the actions of the image forming apparatus 10 of this exemplary embodiment when it executes a function to delete the part of an image contained in a frame area inward from the outer circumference of a document to an extent prescribed by the user (function of frame removal) will be described. The function of frame removal means, as shown in FIG. 13, a function to delete, when a document is to be duplicated, an image in an area inward from the outer circumference of the document to an extent prescribed by the user.

When deletion of an image contained in a frame area inward from the outer circumference of a document to an extent prescribed by the user is designated, the image processing part 35 in this exemplary embodiment functions as a frame removing unit to process frame removal, which is to delete image data contained in a frame area out of the image data of the document scanned by the image scanning part 33. The image storage part 34 stores the image data having gone through the frame removal processing by the image processing part 35.

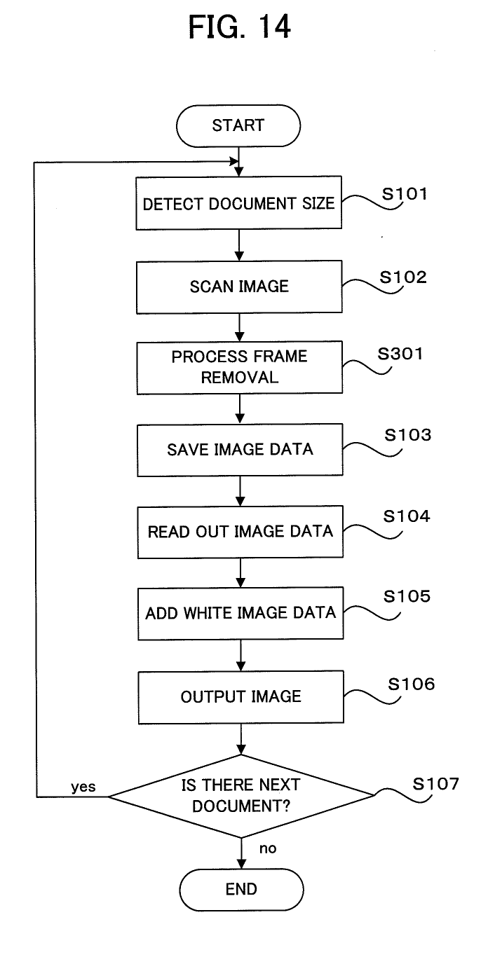

The actions of the image forming apparatus 10 of the exemplary embodiment of the invention to process frame removal are shown in the flowchart of FIG. 14. This flowchart of FIG. 14 represents the addition, to the flowchart of FIG. 6, of step S301 at which frame removal is processed. Thus in the image forming apparatus 10 of this exemplary embodiment, frame removal is processed after step S102 at which image scanning is processed (step S301), and image data storing at step S103 is accomplished following it.

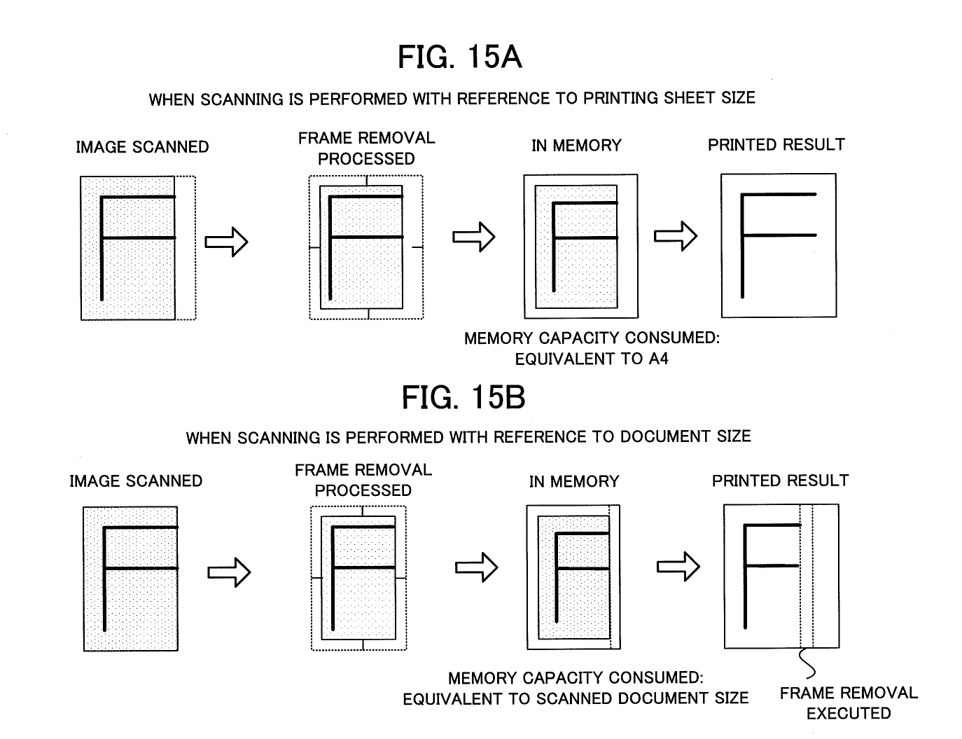

A specific example of this frame removal processing will now be described with reference to FIGS. 15A and 15B. FIGS. 15A and 15B illustrate cases in which a non-standard size document slightly smaller than A4 is outputted with frame removed to an A4 size printing sheet. Further, FIG. 15A shows a case in which scanning is performed with reference to the printing sheet size and FIG. 15B shows a case in which scanning is performed with reference to the document size.

When scanning is performed with reference to the printing sheet size, an image equivalent to the A4 size is scanned in spite of the smaller document size than A4 because the designated printing sheet size is A4 as shown in FIG. 15A, and image data equivalent to A4 that is obtained is subjected to frame removal processing. The part to the right of the document image is not subjected to frame removal processing. The A4 size image data that has been scanned is stored into the image storage part 34. After that, the image is outputted to an A4 size printing sheet on the basis of this A4 size image data.

When scanning is performed with reference to the document size as in this image forming apparatus 10 of this exemplary embodiment, only the text image is scanned even if the document size is smaller than A4 as shown in FIG. 15B. As a result, an image smaller than the A4 size is obtained, and image data equivalent to the document that is obtained is subjected to frame removal processing. As a result, each of the four sides of the document is subjected to frame removal processing only to a designated extent. The document image data that has gone through frame removal processing is stored into the image storage part 34. After that, the image is outputted to an A4 size printing sheet on the basis of this A4 size image data.

### SPECIFIC EXAMPLE 5

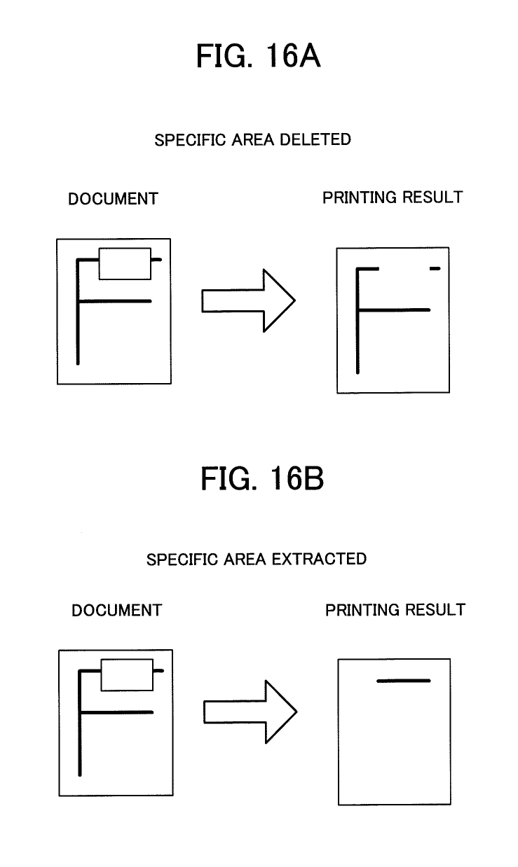

Next, the actions of the image forming apparatus 10 of this exemplary embodiment when it executes a function to extract or delete a specific area in a document will be described. The function to delete means, for instance, when a document is to be duplicated, a function to delete the image in a designated area in the document image and output the remaining part of the document as shown in FIG. 16A. The function to extract means, for instance, when a document is to be duplicated, a function to extract the image in a designated area in the document image and output the extracted image as shown in FIG. 16B. This designation of a specific area is accomplished by setting coordinates with respect to a certain reference position in a document.

When such extraction or deletion of a specific area in a document is designated, the image processing part 35 in this exemplary embodiment functions as a specific area extracting/deleting unit that processes deletion of other image data than that contained in the designated specific area, among the image data of the document scanned by the image scanning part 33, or processes deletion of image data contained in the specific area. Then, the image storage part 34 stores the image data having gone through deletion processing by the image processing part 35.

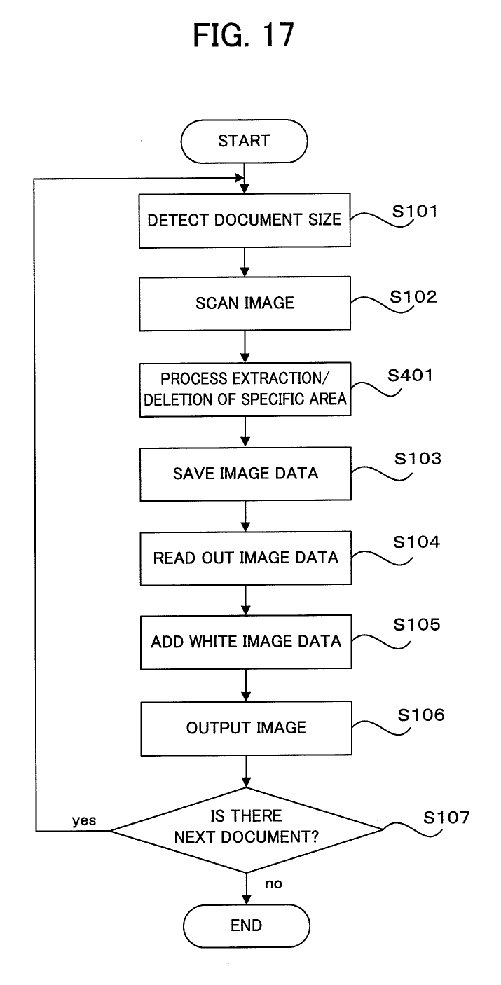

The actions of the image forming apparatus 10 of this exemplary embodiment in the operation to process extraction or deletion of a specific area are shown in the flowchart of FIG. 17. This flowchart of FIG. 17 represents the addition, to the flowchart of FIG. 6, of step S401 at which extraction or deletion of a specific area is processed. Thus, the image forming apparatus 10 of this exemplary embodiment processes extraction or deletion of a specific area (step S401) after step S102 at which scanning of an image is processed, followed by storage of image data at step S103.

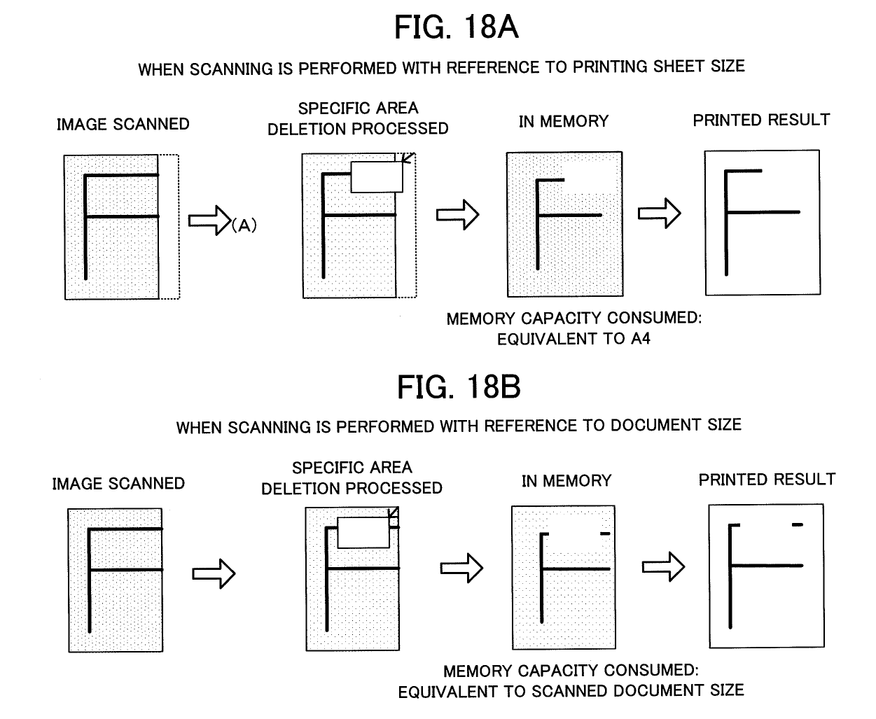

A specific example of this processing to extract a specific area will be described with reference to FIGS. 18A and 18B. FIGS. 18A and 18B illustrate cases in which a non-standard size document slightly smaller than A4 is outputted with a specific area deleted to an A4 size printing sheet. FIG. 18A shows a case in which scanning is performed with reference to the printing sheet size and FIG. 18B shows a case in which scanning is performed with reference to the document size.

When scanning is performed with reference to the printing sheet size, an image equivalent to the A4 size is scanned in spite of the smaller document size than A4 because the designated printing sheet size is A4 as shown in FIG. 18A, and image data equivalent to A4 that are obtained is subjected to processing to delete image data in the designated specific area.

However, since this specific area is designated by coordinates with reference to a certain position of the image data, an image in a position not intended by the user may be deleted depending on the position where this reference point is set. As the upper right on the platen glass 70 is usually set as the starting point of scanning, the top right point of the document is set as the reference position. If the reference point of setting is positioned at the upper right of the document, where the document size is non-standard, gaps arise between the coordinates designated in the state of the document and those on the A4 size image data that has been scanned. For this reason, the area deviating from the user's intention is subjected to deletion processing in the A4 size image data scanned with reference to the printing sheet size. The A4 size image data having undergone processing to delete the specific area are stored into the image storage part 34. After that, the image is outputted to an A4 size printing sheet on the basis of this A4 size image data.

When scanning is performed with reference to the document size as in this image forming apparatus 10 of this exemplary embodiment, only the text image is scanned even if the document size is smaller than A4 as shown in FIG. 18B. As a result, an image smaller than the A4 size is obtained, and image data equivalent to the document that is obtained is subjected to processing to delete a specific area. As the document size at the time the user designated the specific area is the same as that of the scanned image data, no deviation arises. For this reason, deletion of the image in the area intended by the user is processed. Then, the document image data that has gone through deletion of the specific area is stored into the image storage part 34. After that, the image is outputted to an A4 size printing sheet on the basis of this A4 size image data.

### [Modified Version]

Although the foregoing description of this exemplary embodiment referred to an application of the present invention to an image forming apparatus, the invention is not limited to such cases, but can be similarly applied to an image scanning device in which the functions of the image scanning unit 80 shown in FIG. 3 are configured in an independent device.

Also, though the description of this exemplary embodiment above refers to the image processing part 35 as always processing addition of white image data to an area representing the difference between the printing sheet size and the document size in the image data stored in the image storage part 34, the invention is not limited to such cases. For instance, the image processing part 35, though it does not process addition of white image data at normal times, may add white image data only in the processing that follows the resolution of any jamming that has occurred and invited an error. In such a case, the user may be given an option whether or not to add white image data in the processing that follows the resolution of jamming.

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The exemplary embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An image forming apparatus comprising:
a detecting unit that detects a size of a document, a scanning unit that scans a document image on the basis of the document size detected by the detecting unit,
a storage unit that stores a plurality of image data pieces regarding the document image scanned by the scanning unit,
an adding unit that adds, to the image data stored in the storage unit, data to convert an area corresponding to a difference between a size of a printing sheet and the size of the document, into predetermined image, and
an image output unit that outputs image data to which data to convert an area corresponding to the difference between the printing sheet size and the document size into predetermined image, has been added by the adding unit onto a printing sheet of a designated size.

2. The image forming apparatus according to claim 1, wherein the adding unit, when a plurality of document images are to be outputted as a single image, adds, to the plurality of image data pieces stored in the storage unit, data to convert an area corresponding to a difference between a size of a printing sheet and the size of the plurality of documents.

3. The image forming apparatus according to claim 1,
wherein the scanning unit, when a designation to shift a document scanning area is given, scans a document image contained in the shifted document scanning area, and
the storage unit stores image data corresponding to the document image scanned by the scanning unit.

4. The image forming apparatus according to claim 1, further comprising:
a frame removing unit that, when a designation to delete an image contained in a frame area inward from an outer circumference of a document to an extent prescribed by a user is given, processes frame removal to delete image data contained in the frame area out of image data corresponding to the document image scanned by the scanning unit, and
the storage unit stores the image data having undergone frame removal processing by the frame removing unit.

5. The image forming apparatus according to claim 1, further comprising:
a specific area extracting/deleting unit that, when a designation to extract or delete a specific area in a document is given, processes deletion of other image data than image data contained in the designated specific area, among the image data of the document scanned by the scanning unit, or processes deletion of image data contained in the specific area,
wherein the storage unit stores the image data having undergone deletion processing by the specific area extracting/deleting unit.

6. The image forming apparatus according to claim 1, wherein the adding unit, when jamming has occurred, adds, to image data stored in the storage unit, data to convert an area corresponding to a difference between a size of a printing sheet and the size of the document.

7. An image forming system comprising:
a detecting unit that detects a size of a document,
a scanning unit that scans a document image on the basis of the document size detected by the detecting unit,
a storage unit that stores a plurality of image data pieces regarding the document image scanned by the scanning unit,
an adding unit that adds, to the image data stored in the storage unit, data to convert an area corresponding to a difference between a size of a printing sheet and the size of the document, into predetermined image, and
an image output unit that outputs image data to which data to convert an area corresponding to the difference between the printing sheet size and the document size into predetermined image, has been added by the adding unit onto a printing sheet of a designated size .

8. A computer readable medium storing a program for causing a computer to execute a process comprising:
detecting a size of a document,
scanning a document image on the basis of the detected document size,
storing a plurality of image data pieces regarding the scanned document image,
adding data to convert an area corresponding to a difference between a size of a printing sheet and the size of the document to the stored image data, and
outputting image data to which data to convert an area corresponding to the difference between the printing sheet size and the document size into predetermined image, has been added onto a printing sheet of a designated size.

9. An image forming method comprising:
detecting a size of a document,
scanning a document image on the basis of the detected document size,
storing a plurality of image data pieces regarding the scanned document image,
adding data to convert an area corresponding to a difference between a size of a printing sheet and the size of the document to the stored image data, and
outputting image data to which data to convert an area corresponding to the difference between the printing sheet size and the document size into predetermined image, has been added onto a printing sheet of a designated size.
